(19) United States
(12) Patent Application Publication
(10) Pub. No.: US 2016/0083304 A1
(43) Pub. Date: Mar. 24, 2016

(54) ADDITIVE MANUFACTURING OF CERAMIC TURBINE COMPONENTS BY PARTIAL TRANSIENT LIQUID PHASE BONDING USING METAL BINDERS

(71) Applicant: UNITED TECHNOLOGIES CORPORATION, Hartford, CT (US)

(72) Inventors: Sergey Mironets, Charlotte, NC (US); Grant O. Cook, III, Spring, TX (US)

(73) Assignee: United Technologies Corporation, Hartford, CT (US)

(21) Appl. No.: 14/786,493

(22) PCT Filed: Apr. 22, 2014
(86) PCT No.: PCT/US14/34943

§ 371 Date: Oct. 22, 2015

Related U.S. Application Data
(60) Provisional application No. 61/815,802, filed on Apr. 25, 2013.

(51) Int. Cl. C04B 35/653; B28B 1/00; C04B 35/565; C04B 35/10; C04B 35/584

(52) U.S. Cl. CPC C04B 35/653; C04B 35/10; C04B 35/584; C04B 35/565; B28B 1/001; B33Y 10/00

(57) ABSTRACT

A ceramic turbine component is formed by a process including mixing a ceramic powder with a metal binder powder mixture. The powder mixture is then formed into a turbine component that is subsequently densified by partial transient liquid phase sintering. In an embodiment, the turbine component may be formed by an additive manufacturing process such as selective laser sintering.

### BACKGROUND

This invention relates generally to the field of additive manufacturing. In particular, the invention relates to ceramic turbine components formed by an additive manufacturing process and densified by partial transient liquid phase bonding using metal binders.

Additive manufacturing refers to a category of manufacturing methods characterized by the fact that the finished part is created by a layer-wise construction of a plurality of thin sheets of material identical in shape to equivalent planar cross sections of an exact digital model of the part and stored in the memory of the equipment producing the part. Additive manufacturing may involve applying material by a computer controlled process to a work stage and consolidating the material by thermal processes to create a layer. The process is repeated up to several thousand times to arrive at the final component.

Various types of additive manufacturing are known. Additive manufacturing categories as classified by ASTM include material jetting wherein droplets of build material are selectively deposited, powder bed fusion wherein thermal energy selectively fuses regions of a powder bed, directed energy deposition wherein focused thermal energy melts material during deposition, material extrusion wherein material is selectively dispersed through a nozzle, and others. Typical directed energy sources for the above include laser and electron beams.

Recent trends in additive manufacturing toward direct fabrication of production ready metal and ceramic components have minimized the role polymer binders play in the forming process.

### SUMMARY

A method of forming a component includes preparing a starting powder by mixing a first ceramic powder with a metal binder powder mixture. The ceramic and metal powder mixture is then formed into a component by an additive manufacturing process. The component is densified by partial transient liquid phase bonding. In one preferred embodiment, the component may be formed by selective laser sintering. In another preferred embodiment, the component may be a turbine component.

A method includes forming a component from a mixed powder of a first ceramic powder and at least two metal binder powders by a layer by layer additive manufacturing process. The component is heated during forming and during a post forming treatment whereby transient liquid is formed by a reaction between the metal binder powders that wets the ceramic and solidifies to bond the ceramic to the binder phase.

### BRIEF DESCRIPTION OF THE DRAWINGS

FIG. 1 is a schematic of a powder based forming process.

FIG. 2 is an additive manufacturing process of the present invention.

### DETAILED DESCRIPTION

Additive manufacturing is a process wherein three dimensional (3D) objects are produced with a layer by layer technique directly from a digital model. The additive manufacturing process is in distinct contrast to conventional subtractive methods of manufacturing wherein material is removed in a piece by piece fashion from a bank by machining, grinding, etc. or by other forming methods such as forging, casting, injection molding, etc. In additive manufacturing, a piece is formed by the deposition of successive layers of material with each layer adhering to the previous layer until the build is completed. A single layer may be formed by sintering, fusing, or otherwise solidifying specific areas of the top surface of a powder bed or a polymerizable liquid by a computer controlled beam of energy or by depositing individual liquid or semi-solid drops of a material on specific areas of a workpiece by a computer controlled deposition apparatus. Common energy sources are lasers and electron beams.

Additive manufacturing technology was originally used to form polymer models for design and prototyping. Current additive manufacturing processing now produces product from polymers, metal, metal polymer composites, and ceramics. In addition to pre-production designs, and models, current efforts now include direct additive manufacturing fabrication of production parts for obvious reasons. The direct freeform fabrication of a superalloy turbine component, such as an airfoil with internal cooling passages, for example, can eliminate a number of costly manufacturing operations.

Powder based additive manufacturing processes applicable to the present invention include selective laser sintering (SLS), direct laser sintering (DLS), selective laser melting (SLM), direct laser melting (DLM), laser engineered net shaping, electron beam melting (EBM), direct metal deposition, and others known in the art.

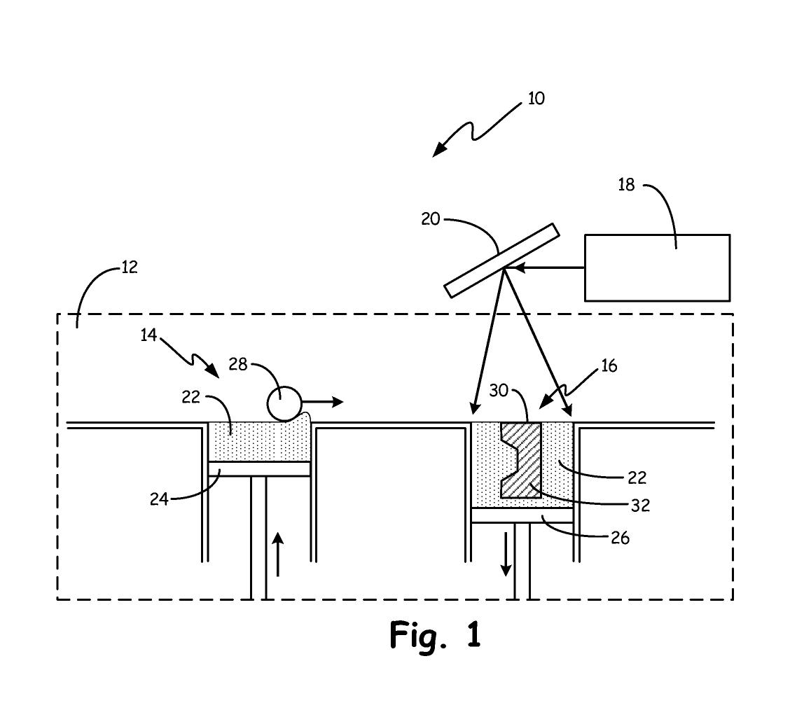

An example of a powder-based additive manufacturing process of the invention is shown in FIG. 1. Process 10 includes manufacturing chamber 12 containing devices that produce solid freeform objects by additive manufacturing. An example of process 10 is selective laser sintering (SLS). SLS process 10 comprises powder storage chamber 14, build chamber 16, laser 18, and scanning mirror 20. During operation of SLS process 10, powder 22 is fed upward by piston 24 and is spread over build platform 26 by roller 28. After powder 22 is spread in an even layer on build platform 26, laser 18 and scanning mirror 20 are activated to direct a laser beam over build platform 26 to sinter selective areas of powder 22 to form a single layer 30 of solid freeform object 32 and to attach the sintered areas to underlying platform 26 according to a 3D computer model of object 32 sorted in an STL memory file in process 10. In the next step, roller 28 is returned to a starting position, piston 24 advances to expose another layer of powder 22 and build platform 26 indexes down by one layer thickness. Roller 28 then spreads a layer of powder 22 over the surface of build platform 26 containing selectively sintered areas. Laser 18 and scanning mirror 20 are activated and selective areas of the deposited layer of powder are again sintered and joined to the underlying layer according to the cross section of the digital model of the component stored in the memory of process 10. The process is repeated until solid freeform part 32 is completed. As mentioned, process 10 is only an example of a solid freeform manufacturing process and is not meant to limit the invention to any single process known in the art.

Chamber 12 of process 10 provides a controlled build environment including inert gases or vacuum. Layer thickness depends on powder size and may range from 20 microns to over a millimeter. Powder 22 may be spread on build platform 26 by roller 28 or another spreading means, such as a scraper.

Other systems, such as direct metal deposition are used in the art wherein material is added bit by bit, according to a controlled distribution process driven by a 3D computer model stored in memory in the deposition equipment. Metal and ceramic powders can be deposited in paste form and metals can be deposited in molten or semi-molten form, and by other deposition processes known in the art. Examples of additive manufacturing processes include, but are not limited to, selective laser sintering (SLS), direct laser sintering (DLS), selective laser melting (SLM), direct laser melting (DLM), laser engineered net shaping (LENS), electron beam melting (EBM), direct metal deposition, and others known in the art.

Polymer binders can aid in adhering powder particles together before, during, and after additive manufacturing. The binder, in powder form, can be mixed with the metal or ceramic starting powder or the starting powders can be coated with a polymer binder. Metal or ceramic parts produced by additive manufacturing wherein a polymer binder is used to improve particle adhesion are usually subjected to a burn out treatment to eliminate the binder from the microstructure before a part is put in service. The polymer may also interfere with particle to particle adhesion during sintering.

Suitable binder systems for the additive manufacturing of sintered ceramic parts of the invention include metal binders. Dimensional control and particle adhesion during sintering are improved when a liquid phase is present. Liquid phase sintering is a process that provides densification and interparticle cohesion to occur while the liquid phase solidifies or is otherwise consumed in the sintering process. The sintered product may exhibit low porosity and acceptable structural integrity.

Many multi-component material systems exist wherein one or more components react during sintering to form a liquid that both enhances densification and dimensional stability. A specific example is when a eutectic or peritectic reaction is present in the composition range of the reactants at a processing temperature of interest. The liquid may be consumed in the process by the surrounding matrix, may solidify by combining with the components to form solid solutions, by precipitating additional intermetallic or ceramic solid phases, by evaporating, or by other means known in the art. In partial transient liquid phase bonding, the binder materials react with each other (eutectic or peritectic), or by other means, wherein a liquid phase forms. Preferably the liquid phase solidifies isothermally. This process is similar to transient liquid phase bonding and is the subject of a related application entitled “Additive manufacturing of ceramic turbine components by transient liquid phase sintering using ceramic binders”, application Ser. No. ______, and filed even date herewith, the entire disclosure of which is incorporated herein by reference.

It is a purpose of this invention to produce freeform ceramic turbine components by laser or electron beam driven additive manufacturing processing from metal binder systems, preferably by partial transient liquid phase bonding. Partial transient liquid phase bonding is distinguished from transient liquid phase bonding in that, during the bonding/sintering process, the mixed binder powder does not interact with the ceramic phase to form low-melting phases. During partial transient liquid bonding, the liquid is only formed by interaction of the constituents in the mixed binder particles. At least two types of binder particles are necessary for partial transient liquid phase bonding. In addition, the liquid that is formed when the mixed binder particles of the invention react with one another and liquefy must wet the ceramic phase. In addition, the mixed binder system preferably is chosen such that the liquid solidifies partially or completely in an isothermal manner by the precipitation of second phases, by matrix solidification, by partial evaporation, or by other means. The binder systems are selected to allow sintering and densification to occur, preferably by transient liquid phase solidification by eutectic, peritectic, or other intercomponent thermal reactions occurring exclusively in the mixed binder liquid phase.

Candidate metal binder systems for partial transient liquid phase sintering of ceramic powders naturally depend on the ceramic component. It is imperative that the liquid binder phase wet the ceramic for successful sintering. Candidate metal binder systems may be materials that react with each other during sintering to form lower melting phases that wet the ceramic. This process may exist in material systems at compositions where eutectic or peritectic reactions occur.

Candidate material systems conforming to the above criteria are reported in “Overview of Transient Liquid Phase and Partial Transient Liquid Phase Bonding”, J. Mater. Sci. 46, 5305 (2011) by one of the inventors and incorporated by reference in entirety herein. Example ceramic systems with transient liquid phase binder additions are shown in the following table.

Ceramic Systems with Partial Transient Liquid Phase Binder Constituents

| | Partial Transient Liquid |
|---|---|
| Ceramic | Phase Binder Constituents |
| Al₂O₃ | Ni, Cu, Cr |
| Al₂O₃ | Ni, Cu |
| Al₂O₃ | Nb, Cu |
| Al₂O₃ | Pt, Cu |
| Al₂O₃ | Ag, Cu, Ti, In |
| Al₂O₃ | Ag, Cu, In |
| Al₂O₃ | Ag, In |
| Al₂O₃ | Nb, Ni |
| Al₂O₃ | Si, Au, Ti, Cu, Sn |
| Al₂O₃ | Al, Ti |
| AlN | Ti, Ag, Cu |
| Si₃N₄ | Ti, Al |
| Si₃N₄ | Ni, Cr, Au |
| Si₃N₄ | Ni, Cu, Au |
| Si₃N₄ | Nb, Co |
| Si₃N₄ | Ta, Co |
| Si₃N₄ | Ti, Co |
| Si₃N₄ | V, Co |
| Si₃N₄ | Ni, Cu, Au, Ti |
| Si₃N₄ | Pd, Cu, Ti |
| Si₃N₄ | Ni, Ti |
| Si₃N₄ | V, Ni |
| Si₃N₄ | Ni, Cu, Ti, Au |
| Si₃N₄ | Ni, Cu, Ti |
| Si₃N₄ | Cu, Ti |
| Si₃N₄ | Stainless steel, Ni, Ti |
| Si₃N₄ | Fe—Ni—Co alloy, Ni, Ti |
| Si₃N₄ | Fe—Cr—Al alloy, Fe, B, Si |
| Si₃N₄ | Fe—Al—Cr—Nb alloy, Cu, Ti, Ni, Al |
| Si₃N₄ | Fe—Al—Cr—Nb alloy, Cu, Ti |
| SiC | Ni, Cu, Au, Ti |
| SiC | Ni, Cu, Ti |
| SiC | Si, C |
| SiC | Fe—Ni—Co alloy, Mo, Si |
| SiC | Mo, Ni, Si |
| TiC | Ni, Nb, Cu |
| TiN | Ni, Nb, Cu |
| WC | Pd, Zn |
| Y₂O₃-stabilized ZrO₂ | Ni, Al, Si |
| Y₂O₃-stabilized ZrO₂ | Nb, Ni |
| Y₂O₃-stabilized ZrO₂ | Ni, Al |
| ZrO₂-toughened Al₂O₃ | Nb, Ni |

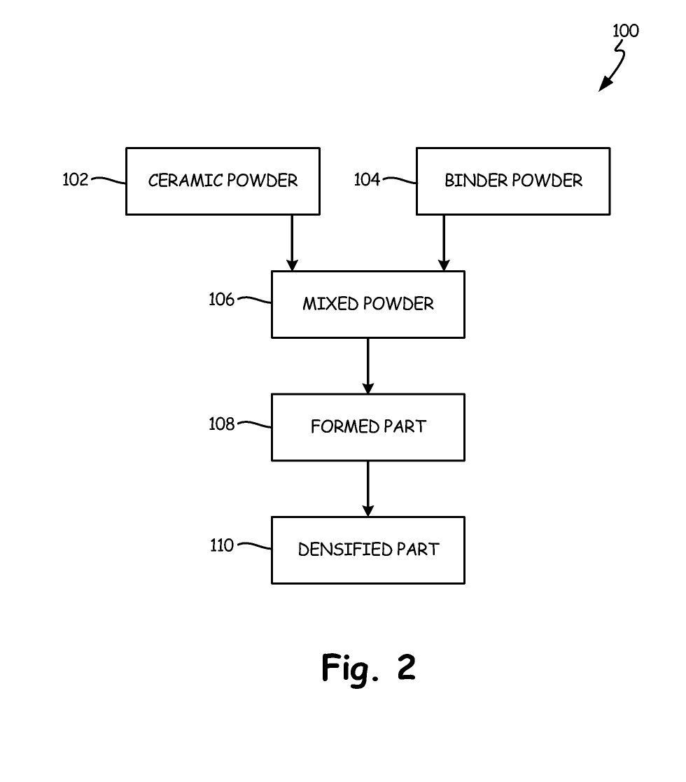

Powder based additive manufacturing process 100 of the present invention is schematically shown in FIG. 2. In the process, ceramic powder 102 and binder powder 104 are mixed to form a starting composition 106. Binder powder 104 may be a metal powder. Binder powder 104 may be chosen such that when mixed with ceramic powder 102 and heated to a sintering temperature, binder powder 104 may melt to form a liquid phase that may wet the ceramic powder.

After ceramic powder 102 and binder powder 104 are mixed to form mixed powder 106, for, for example, additive manufacturing process 10, the starting material is formed into freeform part 30 (Step 108). Additive manufacturing process 10 used for forming may be at least one of direct laser sintering, direct laser melting, selective laser sintering, selective laser melting, laser engineered net shaping, or electron beam melting. Other methods known in the art, such as direct metal deposition, may also be employed. During forming by an additive manufacturing process of the invention, the part may densify by partial transient liquid phase bonding.

Following forming, the additive manufactured freeform part may be densified further by partial transient liquid phase sintering in air, a controlled atmosphere, or in a vacuum (Step 110). A common feature of partial transient liquid phase sintering is isothermal densification while the liquid phase becomes solidified by precipitation of second phases, by matrix solidification, or is partially evaporated.

In an embodiment, aluminum oxide (Al₂O₃) freeform parts are formed and densified by partial transient liquid phase sintering with a nickel-copper-chromium (Ni—Cu—Cr) alloy, a nickel-copper (Ni—Cu) alloy, or a niobium-copper (Nb—Cu) alloy binder system.

In an embodiment, silicon nitride (Si₃N₄) freeform parts are formed and densified by partial transient liquid phase sintering with a titanium-aluminum (Ti—Al) or nickel-chromium-gold (Ni—Cr—Au) alloy binder system.

In an embodiment, silicon carbide (SiC) freeform parts are formed and densified by partial transient liquid phase sintering with nickel-copper-gold-titanium (Ni—Cu—Au—Ti) alloy or silicon-carbon (Si—C) alloy binder systems.

### Discussion of Possible Embodiments

The following are non-exclusive descriptions of possible embodiments of the present invention.

A method for forming a component includes preparing a starting powder by mixing a first ceramic powder with an inorganic binder powder; forming the mixed powder into a component by an additive manufacturing process; and densifying the component by partial transient liquid phase sintering.

The system of the preceding paragraph can optionally include, additionally, and/or alternatively any, one or more of the following features, configurations, and/or additional components:

The densification may occur during forming and during a post forming treatment.

The transient liquid phase may be formed by a reaction between the components of a binder powder that solidifies.

The solidification of the transient liquid phase may be an isothermal process.

The inorganic binder powder material may include a metal.

The first ceramic may be an oxide, nitride, carbide, oxynitride, carbonitride, lanthanide, and mixtures thereof.

The additive manufacturing process may include selective laser sintering, direct laser sintering, selective laser melting, direct laser melting, laser engineered net shaping, electron beam melting, and direct metal deposition.

The component may be a turbine component.

The first ceramic powder may be Al₂O₃, and the inorganic binder powder may be Ni+Cu+Cr, Ni+Cu, Nb+Cu, Pt+Cu, Ag+Cu+Ti+In, Ag+Cu+In, Ag+In, Nb+Ni, Si+Au+Ti+Cu+Sn, or Al+Ti.

The first ceramic powder may be MN and the inorganic binder powder may be Ti+Ag+Cu.

The first ceramic powder may be Si₃N₄ and the inorganic binder powder may be Ti+Al, Ni+Cr+Au, Ni+Cu+Au, Nb+Co, Ta+Co, Ti+Co, V+Co, Ni+Cu+Au+Ti, Pd+Cu+Ti, Ni+Ti, V+Ni, Ni+Cu+Ti+Au, Ni+Cu+Ti, Cu+Ti, stainless steel+Ni+Ti, Fe—Ni—Co alloy+Ni+Ti, Fe—Cr—Al alloy+Fe+B+Si, Fe—Al—Cr—Nb alloy+Cu+Ti+Ni+Al, or Fe—Al—Cr—Nb alloy+Cu+Ti.

The first ceramic powder may be SiC and the inorganic binder powder may be Ni+Cu+Au+Ti, Ni+Cu+Ti, Si+C, Fe—Ni—Co alloy+Mo+Si, or Mo+Ni+Si.

The first ceramic powder may be TiC and the inorganic binder powder may be Ni+Nb+Cu.

The first ceramic powder may be TiN and the inorganic binder powder may be Ni+Nb+Cu.

The first ceramic powder may be WC and the inorganic binder powder may be Pd+Zn.

The first ceramic powder may be Y₂O₃-stabilized ZrO₂ and the binder powder may be Ni+Al+Si, Nb+Ni, or Ni+Al.

The first ceramic powder may be ZrO₂-toughened Al₂O₃ and the binder powder may be Nb+Ni.

A method of forming a component may include forming the component from a mixed powder of a first ceramic powder and at least two metal binder powders by a layer by layer additive manufacturing process; and heating the component to initiate reactions whereby liquid is formed that initiates densification of the component by partial transient liquid phase sintering.

The method of the preceding paragraph can optionally include, additionally, and/or alternatively, any, one or more of the following features, configurations, and/or additional components:

The liquid may be formed by a reaction between the metal binder powders that wets the ceramic and solidifies to bond the first ceramic powder to the binder phase.

The solidification may be an isothermal process.

Although the present invention has been described with reference to preferred embodiments, workers skilled in the art will recognize that changes may be made in form and detail without departing from the spirit and scope of the invention.

1. A method of forming a component comprising:
preparing a starting powder by mixing a first ceramic powder with an inorganic binder powder;
forming the mixed powder into a component by an additive manufacturing process; and
densifying the component by partial transient liquid phase sintering.

2. The method of claim 1, wherein densifying may occur during forming and during a post forming treatment.

3. The method of claim 1, wherein a transient liquid phase is formed by a reaction between the components of a binder powder, that solidifies.

4. The method of claim 3, wherein solidification of the transient liquid phase is an isothermal process.

5. The method of claim 1, wherein inorganic binder powder material consists of a metal.

6. The method of claim 1, wherein first ceramic is from a group consisting of oxides, nitrides, carbides, oxynitrides, carbonitrides, lanthanides, and mixtures thereof.

7. The method of claim 1, wherein additive manufacturing process comprises at least one of selective laser sintering, direct laser sintering, selective laser melting, direct laser melting, laser engineered net shaping, electron beam melting, and direct metal deposition.

8. The method of claim 1, wherein the component is a turbine component.

9. The method of claim 1, wherein the first ceramic powder is Al₂O₃, and the inorganic binder powder is selected from the group consisting of Ni+Cu+Cr, Ni+Cu, Nb+Cu, Pt+Cu, Ag+Cu+Ti+In, Ag+Cu+In, Ag+In, Nb+Ni, Si+Au+Ti+Cu+Sn, and Al+Ti.

10. The method of claim 1, wherein the first ceramic powder is MN and the inorganic binder powder is Ti+Ag+Cu.

11. The method of claim 1, wherein the first ceramic powder is Si₃N₄ and the inorganic binder powder is selected from the group consisting of Ti+Al, Ni+Cr+Au, Ni+Cu+Au, Nb+Co, Ta+Co, Ti+Co, V+Co, Ni+Cu+Au+Ti, Pd+Cu+Ti, Ni+Ti, V+Ni, Ni+Cu+Ti+Au, Ni+Cu+Ti, Cu+Ti, stainless steel+Ni+Ti, Fe—Ni—Co alloy+Ni+Ti, Fe—Cr—Al alloy+Fe+B+Si, Fe—Al—Cr—Nb alloy+Cu+Ti+Ni+Al, and Fe—Al—Cr—Nb alloy+Cu+Ti.

12. The method of claim 1, wherein the first ceramic powder is SiC and the inorganic binder powder is selected from the group consisting of Ni+Cu+Au+Ti, Ni+Cu+Ti, Si+C, Fe—Ni—Co alloy+Mo+Si, and Mo+Ni+Si.

13. The method of claim 1, wherein the first ceramic powder is TiC and the inorganic binder powder is Ni+Nb+Cu.

14. The method of claim 1, wherein the first ceramic powder is TiN and the inorganic binder powder is Ni+Nb+Cu.

15. The method of claim 1, wherein the first ceramic powder is WC and the inorganic binder powder is Pd+Zn.

16. The method of claim 1, wherein the first ceramic powder is Y₂O₃-stabilized ZrO₂ and the binder powder is selected from the group consisting of Ni+Al+Si, Nb+Ni, and Ni+Al.

17. The method of claim 1, wherein the first ceramic powder is ZrO₂-toughened Al₂O₃ and the binder powder is Nb+Ni.

18. A method of forming a component comprising:
forming the component from a mixed powder of a first ceramic powder and at least two metal binder powders by a layer by layer additive manufacturing process; and
heating the component to initiate reactions whereby liquid is formed that initiates densification of the component by partial transient liquid phase sintering.

19. The method of claim 18, wherein the liquid is formed by a reaction between the metal binder powders that wets the ceramic and solidifies to bond the first ceramic powder to the binder phase.

20. The method of claim 11, wherein solidification is an isothermal process.
